(19) United States
(12) Patent Application Publication
(10) Pub. No.: US 2018/0331392 A1
(43) Pub. Date: Nov. 15, 2018

(54) NONAQUEOUS ELECTROLYTE CONTAINING POLAR ORGANIC SOLVENT, PERFLUOROPOLYETHER, AND DIESTER COMPOUND, AND SECONDARY BATTERY INCLUDING THE SAME

(71) Applicant: Panasonic Intellectual Property Management Co., Ltd., Osaka (JP)

(72) Inventors: TOMOFUMI HAMAMURA, Osaka (JP); NOBUHIKO HOJO, Tokyo (JP); HIROTETSU SUZUKI, Osaka (JP)

(21) Appl. No.: 15/937,807

(22) Filed: Mar. 27, 2018

(30) Foreign Application Priority Data
May 12, 2017 (JP) 2017-095173

(51) Int. Cl. H01M 10/0569; H01M 10/0567; H01M 10/0525

(52) U.S. Cl. CPC H01M 10/0569; H01M 10/0567; H01M 2300/0034; H01M 2300/0037; H01M 10/0525

(57) ABSTRACT

A nonaqueous electrolyte includes a nonaqueous solvent and an alkali metal salt dissolved in the nonaqueous solvent. The nonaqueous solvent contains a polar organic solvent, a perfluoropolyether, and a diester compound represented by a formula R¹—O—C(═O)—[—(CF₂)—]ₐ—C(═O)—O—R², where a is an integer of 1 to 4, and each of R¹ and R² represents one selected from the group consisting of an alkyl group having a carbon number of 1 to 4 and a hydrocarbon group which has a carbon number of 1 to 4 and in which at least one hydrogen atom is substituted with fluorine.

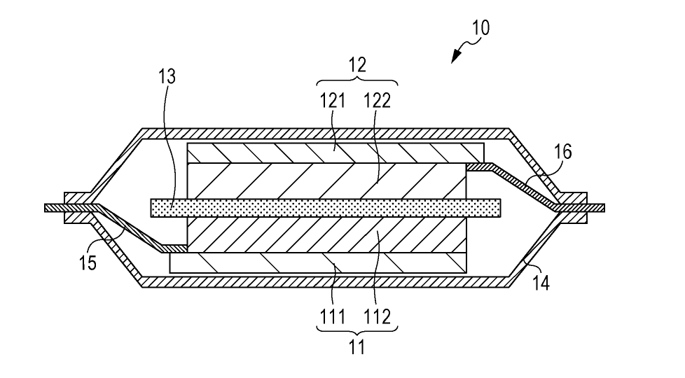

### BACKGROUND

### 1. Technical Field

The present disclosure relates to a nonaqueous electrolyte and a secondary battery including the same and, in particular, relates to an improvement of flame retardancy of a nonaqueous electrolyte.

### 2. Description of the Related Art

To date, perfluoropolyether has been used as a nonaqueous electrolyte additive in batteries. For example, Japanese Unexamined Patent Application Publication No. 2002-305023 and Japanese Unexamined Patent Application Publication No. 2006-269374 disclose that a perfluoropolyether is used for improving the wettability of a nonaqueous electrolyte with respect to the constituents of a battery.

### SUMMARY

In one general aspect, the techniques disclosed here feature a nonaqueous electrolyte including a nonaqueous solvent and an alkali metal salt dissolved in the nonaqueous solvent. The nonaqueous solvent contains a polar organic solvent, a perfluoropolyether, and a diester compound represented by the following formula

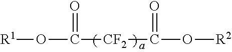

where a is an integer of 1 to 4, and each of R¹ and R² represents one selected from the group consisting of an alkyl group having a carbon number of 1 to 4 and a hydrocarbon group which has a carbon number of 1 to 4 and in which at least one hydrogen atom is substituted with fluorine.

Additional benefits and advantages of the disclosed embodiments will become apparent from the specification and drawing. The benefits and/or advantages may be individually obtained by the various embodiments and features of the specification and drawing, which need not all be provided in order to obtain one or more of such benefits and/or advantages.

### BRIEF DESCRIPTION OF THE DRAWING

FIGURE is a schematic sectional view showing a secondary battery according to an embodiment of the present disclosure.

### DETAILED DESCRIPTION

A nonaqueous electrolyte includes a nonaqueous solvent and an alkali metal salt dissolved in the nonaqueous solvent. In general, perfluoropolyether (PFPE) has low polarity because fluorine atoms having large electronegativity are included. Consequently, PFPE has low solubility of alkali metal salts and does not readily enter between molecules of polar organic solvents having large intermolecular forces. That is, the compatibility between PFPE and polar organic solvents is low, and the two are hardly homogeneously mixed with each other. As a result, the electrical conductivity of a nonaqueous electrolyte containing a polar organic solvent and PFPE as the nonaqueous solvent tends to be low. Therefore, from the viewpoint of maintaining the properties of a nonaqueous electrolyte, it is difficult to add a certain proportion or more (for example, 5 percent by volume or more) of PFPE to a nonaqueous solvent. However, if the content of PFPE in a nonaqueous solvent is about 5 percent by volume, the flame retardancy of the nonaqueous electrolyte is not sufficient.

It was found that the compatibility between PFPE and the polar organic solvent was enhanced by further adding a diester compound having a specific structure to the nonaqueous electrolyte containing the polar organic solvent and PFPE. Consequently, a larger amount of PFPE may be included without impairing the electrical conductivity of the nonaqueous electrolyte. That is, the flame retardancy of the nonaqueous electrolyte is enhanced while maintaining the performance as a nonaqueous electrolyte.

### Nonaqueous Electrolyte

The nonaqueous electrolyte according to the present embodiment includes a nonaqueous solvent and an alkali metal salt dissolved in the nonaqueous solvent. The nonaqueous solvent contains a polar organic solvent, PFPE, and a specific diester compound (hereafter referred to as a “fluorinated diester”.

In such a nonaqueous electrolyte, phase separation of PFPE and the polar organic solvent does not occur. Consequently, PFPE serving as a nonaqueous solvent may be mixed in any proportion. As a result, the flame retardancy of the nonaqueous electrolyte may be enhanced while maintaining the performance as a nonaqueous electrolyte. Therefore, a battery having excellent performance and safety may be realized.

### Fluorinated Diester

The fluorinated diester has two ester groups and, thereby, has high compatibility with the polar organic solvent. Further, the fluorinated diester molecule has a fluorine atom and, thereby, has high compatibility with PFPE. As a result, the polar organic solvent and PFPE are homogeneously mixed with each other in the presence of the fluorinated diester.

The fluorinated diester is denoted by formula (1) described below.

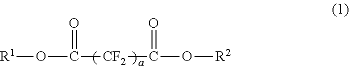

In the formula, a represents an integer of 1 to 4. When the number of fluorinated carbon groups (—CF₂—) which are interposed between two ester groups is within this range, the compatibility with the polar organic solvent is enhanced and, in addition, an increase in the viscosity of the fluorinated diester is suppressed. The value of a may be 2 to 4 and, for example, 2. In this case, the solubility of the alkali metal salt is increased.

The solubility parameter (SP value) of the fluorinated diester may be within the range of 8 to 13. Consequently, the compatibility between the polar organic solvent and the fluorinated diester is enhanced.

In the formula, each of R¹ and R² represents an alkyl group having a carbon number of 1 to 4 (a methyl group, an ethyl group, a propyl group, or a butyl group) or a hydrocarbon group which has a carbon number of 1 to 4 and in which at least one hydrogen atom is substituted with fluorine. Consequently, the compatibility with the polar organic solvent is enhanced. Each of R¹ and R² may be an alkyl group having a carbon number of 1 to 4. A propyl group and a butyl group may have a structure of a straight chain or may be branched. In particular, the carbon number of each of R¹ and R² may be 1 or 2. R¹ and R² may be the same or different from each other.

### Polar Organic Solvent

There is no particular limitation regarding the polar organic solvent as long as the alkali metal salt is dissolved, and examples of the polar organic solvent include carbonic acid esters, carboxylic acid esters, phosphoric acid esters, sulfones, and ethers.

Examples of carbonic acid esters include cyclic carbonic acid esters, e.g., propylene carbonate, ethylene carbonate, fluoroethylene carbonate, vinylene carbonate, and vinylethylene carbonate, and chain carbonic acid esters, e.g., diethyl carbonate, ethylmethyl carbonate, and dimethyl carbonate. Examples of carboxylic acid esters include γ-butyrolactone and γ-valerolactone. Examples of phosphoric acid esters include trimethyl phosphate and triethyl phosphate. Examples of sulfones include sulfolane and methylsulfolane. Examples of ethers include cyclic ethers, e.g., 1,3-dioxolane, and chain ethers, e.g., 1,2-dimethoxyethane and 1,2-diethoxyethane. These are used alone, or at least two types are used in combination.

The polar organic solvent may be a carbonic acid ester, a carboxylic acid ester, or a phosphoric acid ester from the viewpoint of a high dielectric constant and the solubility of the alkali metal salt. The polar organic solvent may be, for example, a cyclic carbonic acid ester. Consequently, the electrical conductivity of the nonaqueous electrolyte is further increased.

### Perfluoropolyether

There is no particular limitation regarding PFPE as long as at least one unit (—CₙF₂ₙ—O—) having a structure in which an entirely fluorinated carbon chain is bonded to an oxygen atom is included. In the present embodiment, a fluorinated diester is also used and, thereby, phase separation of the nonaqueous solvent is suppressed. As a result, PFPE including the above-described unit that contains no hydrogen atom can be used. Such PFPE has high flame retardancy and relatively low viscosity. Therefore, PFPE is suitable for a nonaqueous electrolyte.

The weight average molecular weight (Mw) of PFPE may be 350 or more and 2,000 or less, and further may be 350 or more and less than 1,100. When the Mw of PFPE is within this range, the boiling temperature is higher than or equal to a common operating temperature (for example, 60° C. or higher) of a battery, safety is enhanced, and viscosity is controlled at a low level.

The weight average molecular weight (Mw) is determined by dividing the sum total of the products of the molecular weight and the weight of the respective molecules by the total weight. Experimentally, Mw is calculated on the basis of a measuring method called gel permeation chromatography (GPC). GPC is one type of liquid chromatography that performs separation based on the difference in molecular size and is a technique used to measure the molecular weight distribution of a compound and the average molecular weight distribution. The Mw of a compound is calculated by combining a GPC measuring device with a light scattering detector.

PFPE is denoted by, for example, general formula (2) described below.

R₃—OC_{b}F_{2b}—OₚC_{c}F_{2c}—O_{q}R⁴ (2)

In formula (2), each of R³ and R⁴ that is an end group may contain an oxygen atom that may be coordinated with an alkali metal ion so that dissolution of an alkali metal salt is facilitated. Each of R³ and R⁴ that is an end group may contain a fluorine atom so that the flame retardancy is further enhanced. Examples of R³ and R⁴ include a carboxylic acid ester denoted by —CₓF₂ₓ—C_{y}H_{2y}—COO—C_{z}H_{2z+1}, an alkyl ether denoted by —CₓF₂ₓ—C_{y}H_{2y}—O—C_{z}H_{2z+1}, a carbonic acid ester denoted by —CₓF₂ₓ—C_{y}H_{2y}—O—COO—C_{z}H_{2z+1}, and a perfluoroalkyl group having a carbon number of 1 to 5. The perfluoroalkyl group may have a structure of a straight chain, may be branched, or may be cyclic. R³ and R⁴ may be the same or different from each other. However, the perfluoroalkyl group may be any one of R³ and R⁴ provided that the polarity of PFPE is not excessively reduced.

In formula (2), b represents the carbon number of an entirely fluorinated carbon chain in a [—(C_{b}F_{2b}—O)—]unit (hereafter referred to as a first unit), c represents the carbon number of an entirely fluorinated carbon chain in a [—(C_{b}F_{2c}—O)—]unit (hereafter referred to as a second unit), each of x, y, and z represents the carbon number of an end group, p and q, b and c, and x, y, and z may be appropriately set such that the Mw of PFPE becomes 350 or more and 2,000 or less. In this regard, each of b and c is, for example, an integer of 1 to 3, and b and c may be the same or different from each other, each of x and y is, for example, an integer of 0 to 3, and x and y may be the same or different from each other, and z is, for example, an integer of 1 to 3.

In formula (2), p represents the number of the first units, q represents the number of the second units, p and q satisfy, for example, p≥0, q≥0, and 1≤p+q≤40, p and q are not limited to integers, and p and q may further satisfy 1≤p+q≤20.

Each of the first unit and the second unit may have a structure of a straight chain or may be branched. Examples of straight chain first units and/or second units include —(CF₂—O)—, —(CF₂CF₂—O)—, and —(CF₂CF₂CF₂—O)—. Examples of branched first units and/or second units include —(CF(CF₃)CF₂—O)—, —(CF₂CF(CF₃)—O)—, and —(C(CF₃)₂—O)—.

In formula (2), both the first unit and the second unit may have a structure of a straight chain or may be branched. Alternatively, one may have a structure of a straight chain and the other may be branched. Examples of combinations of a straight chain first unit and a straight chain second unit include —(CF₂CF₂CF₂—O—)ₚ—(CF₂—O—)_{q}—, —(CF₂CF₂—O—)ₚ—(CF₂—O—)_{q}—, and —(CF₂CF₂CF₂—O—)ₚ—(CF₂CF₂—O—)_{q}—.

Examples of combinations of a branched first unit and a branched second unit include —(CF₂CF(CF₃)—O—)ₚ—(CF(CF₃)CF₂—O—)_{q}— and —(C(CF₃)₂—O—)ₚ—(CF(CF₃)CF₂—O—)_{q}—.

Examples of combinations of a branched first unit and a straight chain second unit include —(CF(CF₃)CF₂—O—)ₚ—(CF₂CF₂—O—)_{q}—, —(CF(CF₃)CF₂—O—)ₚ—(CF₂CF₂CF₂—O—)_{q}—, and —(CF₂CF(CF₃)—O—)ₚ—(CF₂CF₂—O—)_{q}—.

When neither p nor q is 0, the first units and the second units may be regularly arranged or randomly arranged, or blocks of the first units and blocks of the second units may be arranged.

When each of R³ and R⁴ is a carboxylic acid ester denoted by —CₓF₂x—C_{y}H_{2y}—COO—C_{z}H_{2z+1}, for example, x=2, y=0, and z=1 are satisfied, and in formula (2), b=3, c=3, and 1≤p+q≤20 are satisfied. Use of such PFPE easily realizes an effect of enhancing compatibility with a polar organic solvent due to the fluorinated diester.

When each of R³ and R⁴ is an alkyl ether denoted by —CₓF₂ₓ—C_{y}H_{2y}—O—C_{z}H_{2z+1}, from the same viewpoint, x=2, y=1, and z=1 may be satisfied, and in formula (2), b=3, c=3, and 1≤p+q≤20 may be satisfied.

When each of R³ and R⁴ is a carbonic acid ester denoted by —CₓF₂ₓ—C_{y}H_{2y}—O—COO—C_{z}H_{2z+1}, from the same viewpoint, x=2, y=1, and z=1 may be satisfied, and in formula (2), b=3, c=3, and 1≤p+q≤20 may be satisfied.

The nonaqueous solvent may contain one type of PFPE or may contain at least two types of PFPE having compositions or structures different from each other.

PFPE may be synthesized by known methods, e.g., a reaction that utilizes photooxidation of a perfluoroolefin and an anionic polymerization reaction of an entirely fluorinated epoxide. Synthesized PFPE may be subjected to precision distillation or column refining so as to produce PFPE having a predetermined Mw.

### Nonaqueous Solvent

The nonaqueous solvent includes a polar organic solvent, PFPE, and a fluorinated diester.

From the viewpoint of flame retardancy, the volume proportion of PFPE in the nonaqueous solvent may be 10% or more, and further 20% or more. According to the present embodiment, even when the above-described volume proportion of PFPE is 10% or more, phase separation of the nonaqueous solvent is suppressed. Therefore, electrical conductivity can be maintained while enhancing the flame retardancy of a nonaqueous electrolyte. From the viewpoint of the solubility of an alkali metal salt, the volume proportion of PFPE in the nonaqueous solvent may be 40% or less.

From the viewpoint of suppressing phase separation of the nonaqueous solvent, the volume ratio of the fluorinated diester to PFPE may be 1.5 or more and 5 or less, and further 2 or more and 4 or less.

From the viewpoint of the solubility of an alkali metal salt, the volume proportion of the polar organic solvent in the nonaqueous solvent may be 10% or more, and further 20% or more. From the viewpoint of flame retardancy, the volume proportion of the polar organic solvent in the nonaqueous solvent may be 70% or less, and further 60% or less.

### Alkali Metal Salt

The alkali metal salt is composed of an alkali metal cation and an anion and is denoted by the formula MX. In the formula MX, M represents an alkali metal, examples of which include Na, Li, K, Rb, and Cs.

Examples of X in the formula MX include Cl, Br, I, BF₄, PF₆, CF₃SO₃, ClO₄, CF₃CO₂, AsF₆, SbF₆, AlCl₄, N(CF₃SO₂)₂, N(FSO₂)₂, N(CF₃CF₂SO₂)₂, and N(CF₃SO₂)(FSO₂). From the viewpoint of chemical stability, X in the formula MX may be BF₄, PF₆, ClO₄, N(CF₃SO₂)₂, or N(CF₃CF₂SO₂)₂. From the viewpoint of solubility, X in the formula MX may be N(CF₃SO₂)₂, N(FSO₂)₂, N(CF₃CF₂SO₂)₂, or N(CF₃SO₂)(FSO₂). These may be used alone, or at least two types may be used in combination.

There is no particular limitation regarding the concentration of the alkali metal salt, and from the viewpoint of electrical conductivity, the concentration may be adjusted such that alkali metal salt/nonaqueous solvent=1/2 to 1/20 (molar ratio).

### Battery

A battery according to the present embodiment includes the above-described nonaqueous electrolyte, a positive electrode, and a negative electrode. The nonaqueous electrolyte, the positive electrode, and the negative electrode are accommodated in a case with a bottom or are laminated by a film material. The battery may be a primary battery or a secondary battery.

### Positive Electrode

The positive electrode contains a positive electrode active material that can occlude and release alkali metal cations.

Such a positive electrode is produced by, for example, forming a positive electrode mix containing the positive electrode active material into the shape of a disk. Alternatively, the positive electrode is produced by making a positive electrode collector hold a layer containing the positive electrode mix (positive electrode mix layer).

The positive electrode mix layer may be held on the positive electrode collector by mixing the positive electrode mix and a liquid component so as to make a slurry, coating the surface of the positive electrode collector with the resulting slurry, and performing drying. The positive electrode mix layer may include a conductive auxiliary agent, an ionic conductor, a binder, and the like. A carbon material, e.g., carbon, may be interposed between the positive electrode collector and the positive electrode mix layer. Consequently, a reduction in the resistance value, a catalyst effect, and enhancement of, for example, adhesion between the positive electrode mix layer and the positive electrode collector are expected. There is no particular limitation regarding the thickness of the positive electrode collector, and the thickness may be, for example, 5 to 300 μm. There is no particular limitation regarding the thickness of the positive electrode mix layer, and the thickness may be, for example, 30 to 300 μm.

Regarding the positive electrode active material, when the alkali metal is lithium, a known material that can occlude and release lithium ions is used. Examples of positive electrode active materials include transition metal oxides, lithium-containing transition metal oxides, lithium-transition metal phosphoric acid compounds (LiFePO₄ and the like), and lithium-transition metal sulfuric acid compounds (LiₓFe₂(SO₄)₃ and the like).

Examples of transition metal oxides include cobalt oxides, nickel oxides, manganese oxides, vanadium oxides represented by vanadium pentoxide (V₂O₅), and complex oxides of these transition metals. Examples of lithium-containing transition metal oxides include lithium-manganese complex oxides (LiMn₂O₄ and the like), lithium-nickel complex oxides (LiNiO₂ and the like), lithium-cobalt complex oxides (LiCoO₂ and the like), lithium-iron complex oxides (LiFeO₂ and the like), lithium-nickel-cobalt-manganese complex oxides (LiNi_{0.5}Co_{0.2}Mn_{0.3}O₂, LiNi_{1/3}Co_{1/3}Mn_{1/3}O₂, LiNi_{0.4}Co_{0.2}Mn_{0.4}O₂, and the like), lithium-nickel-cobalt-aluminum complex oxides (LiNi_{0.8}Co_{0.15}Al_{0.05}O₂, LiNi_{0.8}Co_{0.18}Al_{0.02}O₂, and the like), lithium-nickel-manganese complex oxides (LiNi_{0.5}Mn_{0.5}O₂ and the like), and lithium-nickel-cobalt complex oxides (LiNi_{0.8}Co_{0.2}O₂ and the like). From the viewpoint of energy density, the positive electrode active material may be a lithium-cobalt complex oxide, a lithium-nickel-cobalt-manganese complex oxide, or a lithium-nickel-cobalt-aluminum complex oxide.

Regarding the positive electrode active material, when the alkali metal is sodium, a known material that can occlude and release sodium ions is used. Examples of positive electrode active materials include transition metal oxides, sodium-containing transition metal oxides, sodium-transition metal phosphoric acid compounds (NaFePO₄ and the like), and sodium-transition metal sulfuric acid compounds (NaₓFe₂(SO₄)₃ and the like).

Examples of transition metal oxides include the same materials described as transition metal oxides that can occlude and release lithium ions. Examples of sodium-containing transition metal oxides include sodium manganate (NaMnO₂), sodium chromite (NaCrO₂), and sodium iron manganate (Na_{2/3}Fe_{1/3}Mn_{2/3}O₂).

Examples of positive electrode collectors include a sheet (foil, mesh, or the like) or film that contains a metal material, e.g., aluminum, stainless steel, titanium, or an alloy thereof. From the viewpoint of cost, the positive electrode collector may be a sheet containing aluminum or an alloy thereof. The positive electrode collector may be porous or nonporous.

A conductive auxiliary agent is used to reduce the resistance of the positive electrode. Examples of conductive auxiliary agents include carbon materials, e.g., carbon black, graphite, and acetylene black, and conductive polymers, e.g., polyanilines, polypyrroles, and polythiophenes. The amount of the conductive auxiliary agent included in the positive electrode mix is, for example, 5 to 30 parts by mass relative to 100 parts by mass of the positive electrode active material.

An ionic conductor is used to reduce the resistance of the positive electrode. Examples of ionic conductors include gel electrolytes, e.g., polymethyl methacrylate, and solid electrolytes, e.g., polyethylene oxide. The amount of the ionic conductor included in the positive electrode mix is, for example, 5 to 30 parts by mass relative to 100 parts by mass of the positive electrode active material.

A binder is used to improve the binding properties of a material included in the positive electrode mix layer. Examples of binders include polyvinylidene fluorides, vinylidene fluoride-hexafluoropropylene copolymers, vinylidene fluoride-tetrafluoroethylene copolymers, polytetrafluoroethylenes, carboxymethyl cellulose, polyacrylic acids, styrene-butadiene copolymer rubbers, polypropylenes, polyethylenes, and polyimides. The amount of the binder included in the positive electrode mix is, for example, 3 to 15 parts by mass relative to 100 parts by mass of the positive electrode active material.

### Negative Electrode

The negative electrode contains a negative electrode active material that can occlude and release alkali metal cations. Alternatively, the negative electrode contains a material that can dissolve or precipitate an alkali metal serving as a negative electrode active material.

Such a negative electrode may be formed by, for example, stamping an alkali metal simple substance and/or an alkali metal alloy into a predetermined shape and performing contact bonding to a negative electrode collector. Alternatively, the negative electrode is formed by performing electrodeposition, evaporation, or the like of an alkali metal simple substance and/or an alkali metal onto the negative electrode collector. In this regard, in the same manner as for the positive electrode, there is no particular limitation regarding the thickness of the negative electrode collector produced by making the negative electrode collector hold a layer of a negative electrode mix containing a negative electrode active material (negative electrode mix layer), and the thickness is, for example, 5 to 300 μm. Also, there is no particular limitation regarding the thickness of the negative electrode mix layer, and the thickness is, for example, 30 to 300 μm. The negative electrode mix layer may include the above-described conductive auxiliary agent, ionic conductor, binder, and the like. A carbon material, e.g., carbon, may be interposed between the negative electrode collector and the negative electrode mix layer.

When the alkali metal is lithium, examples of negative electrode active materials include a metal lithium simple substance, lithium alloys, silicon, silicon alloys, nongraphitizable carbon, and lithium-containing metal oxides. Examples of nongraphitizable carbon include graphite, hard carbon, and coke. Examples of lithium-containing metal oxides include lithium titanate (Li₄Ti₅O₁₂). Lithium alloys are alloys containing lithium and an element Y other than lithium. The element Y is, for example, silicon, tin, or aluminum. The content of the element Y included in the lithium alloy may be 20% or less on an atomic ratio basis.

When the alkali metal is sodium, examples of negative electrode active materials include a metal sodium simple substance, sodium alloys, silicon, silicon alloys, nongraphitizable carbon, and sodium-containing metal oxides. Examples of nongraphitizable carbon include the same materials described as nongraphitizable carbon that can occlude and release lithium ions. Examples of sodium-containing metal oxides include sodium titanate (Na₂Ti₃O₇, Na₄Ti₅O₁₂). Sodium alloys are alloys containing sodium and an element Z other than sodium. The element Z is, for example, tin, germanium, zinc, bismuth, or indium. The content of the element Z included in the sodium alloy may be 20% or less on an atomic ratio basis.

Examples of negative electrode collectors include a sheet (foil, mesh, or the like) or film that contains a metal material (e.g., aluminum, stainless steel, nickel, or copper) or an alloy thereof. From the viewpoint of cost, the negative electrode collector may be a sheet containing aluminum or an alloy thereof. The negative electrode collector may be porous or nonporous.

FIGURE is a schematic sectional view showing a battery (secondary battery) according to the present embodiment.

A battery 10 includes a nonaqueous electrolyte which is not shown in the drawing, a positive electrode 11, and a negative electrode 12. The battery 10 is a laminate-type battery, and the nonaqueous electrolyte, the positive electrode 11, and the negative electrode 12 are laminated by a film-like outer jacket 14.

The positive electrode 11 and the negative electrode 12 are opposed to each other with a separator 13 interposed therebetween so as to constitute an electrode group. The positive electrode 11 includes a positive electrode collector 111 and a positive electrode mix layer 112 held on the positive electrode collector 111. The negative electrode 12 includes a negative electrode collector 121 and a negative electrode mix layer 122 held on the negative electrode collector 121. A positive electrode lead terminal 15 is connected to the positive electrode collector 111. The positive electrode lead terminal 15 extends outside the outer jacket 14. Likewise, a negative electrode lead terminal 16 is connected to the negative electrode collector 121. The negative electrode lead terminal 16 extends outside the outer jacket 14.

Examples of the separator 13 include porous films formed of polyethylene, polypropylene, glass, cellulose, and ceramic. Pores of the porous film are impregnated with the nonaqueous electrolyte.

### EXAMPLES

The nonaqueous electrolyte according to the present embodiment will be described below in detail with reference to the examples. However, the present disclosure is not limited to the following examples.

The homogeneity of the nonaqueous electrolyte was evaluated.

### Example 1

A nonaqueous solvent was produced by mixing fluoroethylene carbonate (polar organic solvent), a fluorinated diester described below, and PFPE described below in a ratio shown in Table. Nonaqueous electrolyte A was produced by dissolving lithium hexafluorophosphate (LiPF₆, alkali metal salt) into the nonaqueous solvent such that the concentration became 0.15 percent by mole. Nonaqueous electrolyte A was prepared in an argon glove box.

Dimethyl tetrafluorosuccinate (CAS No. 356-36-5) denoted by formula (1a) was used as the fluorinated diester.

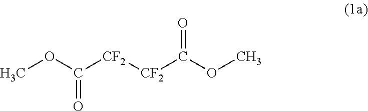

A compound (perfluoro(2,5-dimethyl-3,6-dioxanonanoic acid), methyl ester, CAS No. 26131-32-8, Mw: 509) denoted by formula (2a) was used as PFPE.

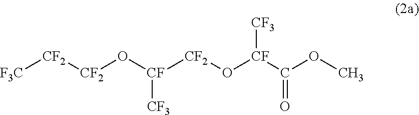

The homogeneity of the resulting nonaqueous electrolyte A was visually evaluated. When precipitation of the alkali salt and/or phase separation of the solvents from each other was observed, the rating was “poor”. When neither precipitation of the alkali salt nor phase separation of the solvents from each other was observed, the rating was “good”. The evaluation results are shown in Table.

### Example 2

Nonaqueous electrolyte B was prepared in the same manner as in example 1 except that the mixing ratio of the polar organic solvent, the fluorinated diester, and PFPE was changed, and the evaluation was performed. The mixing ratio of each solvent and the evaluation result are shown in Table.

### Example 3

Nonaqueous electrolyte C was prepared in the same manner as in example 1 except that the mixing ratio of the polar organic solvent, the fluorinated diester, and PFPE was changed, and the evaluation was performed. The mixing ratio of each solvent and the evaluation result are shown in Table.

### Example 4

Nonaqueous electrolyte D was prepared in the same manner as in example 1 except that the mixing ratio of the polar organic solvent, the fluorinated diester, and PFPE was changed, and the evaluation was performed. The mixing ratio of each solvent and the evaluation result are shown in Table.

### Comparative Example 1

Nonaqueous electrolyte a was prepared in the same manner as in example 1 except that the fluorinated diester was not used and the mixing ratio of the polar organic solvent and PFPE was changed, and the evaluation was performed. The mixing ratio of each solvent and the evaluation result are shown in Table.

### Comparative Example 2

Nonaqueous electrolyte b was prepared in the same manner as in example 1 except that the fluorinated diester was not used and the mixing ratio of the polar organic solvent and PFPE was changed, and the evaluation was performed. The mixing ratio of each solvent and the evaluation result are shown in Table.

The performance of the battery was evaluated as described below.

### Example 5

### (1) Production of Positive Electrode

A slurry was produced by dispersing LiNi_{0.8}Co_{0.18}Al_{0.02}O₂ (positive electrode active material, hereafter referred to as NCA), acetylene black (conductive auxiliary agent, hereafter referred to as AB), and polyvinylidene fluoride (binder, hereafter referred to as PVDF) into N-methyl-2-pyrrolidone so as to satisfy NCA/AB/PVDF=8/1/1 (weight ratio). One surface of aluminum foil (positive electrode collector) was coated with the resulting slurry, and drying was performed at 105° C. so as to form a positive electrode mix layer. Subsequently, the resulting multilayer body composed of the aluminum foil and the positive electrode mix layer was rolled and stamped into a 20-mm square so as to produce a positive electrode.

### (2) Production of Negative Electrode

Lithium metal foil was contact-bonded to a 20-mm square nickel mesh so as to produce a negative electrode.

### (3) Production of Battery

The positive electrode and the negative electrode, which were produced as described above, were opposed to each other with a separator (polyethylene microporous film) interposed therebetween so as to produce an electrode group. A laminate-type lithium secondary battery was produced by laminating the electrode group and nonaqueous electrolyte C prepared in example 3 with a film material (multilayer body including a resin layer and an aluminum layer).

### (4) Evaluation of Discharge Capacity

The resulting lithium secondary battery was subjected to a charge and discharge test in a constant temperature bath at 25° C. under the following conditions. The charge and discharge test was started from charge, and a cycle of charge and discharge was repeated three times. A stable charge and discharge operation was established at the third cycle.

### Charge

Constant-current constant-voltage charge was performed at a current value of 0.05 C rate relative to a theoretical capacity of the positive electrode active material. The upper limit voltage of the charge was set to be 4.2 V. The lower limit current value at constant voltage was set to be 0.05 C rate.

### Discharge

The lower limit voltage of discharge was set to be 2.5 V, and discharge was performed at a current value of 0.05 C rate. After suspension for 30 minutes, discharge was performed at a current value of 0.02 C rate.

The discharge capacity of the third cycle was calculated as the value converted to the capacity per gram of positive electrode active material (mAhg⁻¹). The result was 191 mAhg⁻¹. Consequently, it was shown that nonaqueous electrolyte C could be used for the secondary battery.

Next, the safety of the battery was evaluated.

### Example 6

A lithium secondary battery produced in the same manner as in example 5 was charged under the above-described conditions. The lithium secondary battery in the charged state was disassembled and the positive electrode was taken out. The positive electrode taken out was subjected to differential scanning calorimetry under the condition of the temperature increase rate of 10° C./min and the measurement temperature range of 30° C. to 300° C. The heat release (kJ/g) was determined by dividing the measured differential scanning calorie by the mass of the positive electrode active material. The result is shown in Table.

### Comparative Example 3

A lithium secondary battery was produced in the same manner as in example 5 except that nonaqueous electrolyte a prepared in comparative example 1 was used, and charge was performed. The lithium secondary battery in the charged state was disassembled and the positive electrode was taken out. The heat release was calculated in the same manner as in example 6. The result is shown in Table.

TABLE

| | Volume proportion | | | | |
|---|---|---|---|---|---|
| | of each solvent (%) | | | | Heat |
| Nonaqueous | Polar organic | | Fluorinated | | release |
| electrolyte | solvent | PFPE | diester | homogeneity | (kJ/g) |
| A | 60 | 10 | 30 | good | — |
| B | 50 | 10 | 40 | good | — |
| C | 40 | 20 | 40 | good | 23.0 |
| D | 20 | 20 | 60 | good | — |
| a | 95 | 5 | 0 | good | 27.5 |
| b | 90 | 10 | 0 | poor | — |

As shown in Table, nonaqueous electrolytes A to D were homogeneous without phase separation in spite of the PFPE content being 10 percent by volume or more in the nonaqueous solvent. The alkali metal salt was dissolved in nonaqueous electrolytes A to D without phase separation. On the other hand, regarding nonaqueous electrolyte b containing 10 percent by volume of PFPE in the nonaqueous solvent, phase separation was observed. Consequently, it was found that the homogeneity of the nonaqueous solvent containing PFPE was enhanced by the fluorinated diester.

Regarding nonaqueous electrolyte a containing 5 percent by volume of PFPE in the nonaqueous solvent, the homogeneity was good. However, the heat release was large and the flame retardancy was poor compared with nonaqueous electrolyte C containing 20 percent by volume of PFPE in the nonaqueous solvent.

What is claimed is:

1. A nonaqueous electrolyte comprising:
a nonaqueous solvent containing
a polar organic solvent,
a perfluoropolyether, and
a diester compound represented by the following formula 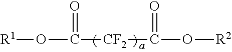
where a is an integer of 1 to 4, and each of R¹ and R² represents one selected from the group consisting of an alkyl group having a carbon number of 1 to 4 and a hydrocarbon group which has a carbon number of 1 to 4 and in which at least one hydrogen atom is substituted with fluorine; and
an alkali metal salt dissolved in the nonaqueous solvent.

2. The nonaqueous electrolyte according to claim 1,
wherein the polar organic solvent includes at least one selected from the group consisting of a carbonic acid ester, a carboxylic acid ester, and a phosphoric acid ester.

3. The nonaqueous electrolyte according to claim 1,
wherein the polar organic solvent includes a cyclic carbonic acid ester.

4. The nonaqueous electrolyte according to claim 1,
wherein the perfluoropolyether is represented by the following formula
R³—OC_{b}F_{2b}—OₚC_{c}F_{2c}—O_{q}R⁴
where each of R³ and R⁴ represents one selected from the group consisting of a carboxylic acid ester denoted by —CₓF₂ₓ—C_{y}H_{2y}—COO—C_{z}H_{2z+1}, —CₓF₂ₓ—C_{y}H_{2y}—O—C_{z}H_{2z+1}, —CₓF₂ₓ—C_{y}H_{2y}—O—COO—C_{z}H_{2z+1}, and a perfluoroalkyl group having a carbon number of 1 to 5, each of b and c is an integer of 1 to 3, each of x and y is an integer of 0 to 3, z is an integer of 1 to 3, and p≥q≥0, and 1≤p+q≤40.

5. The nonaqueous electrolyte according to claim 1,
wherein a volume proportion of the perfluoropolyether in the nonaqueous solvent is 10% or more.

6. The nonaqueous electrolyte according to claim 1,
wherein a volume ratio of the diester compound to the perfluoropolyether is 2 or more and 4 or less.

7. The nonaqueous electrolyte according to claim 1,
wherein the a is 2.

8. The nonaqueous electrolyte according to claim 1,
wherein a solubility parameter of the diester compound is 8 or more and 13 or less.

9. A secondary battery comprising:
the nonaqueous electrolyte according to claim 1;
a positive electrode containing a positive electrode active material that can occlude and release alkali metal cations; and
a negative electrode containing a negative electrode active material that can occlude and release alkali metal cations or containing a material that allows an alkali metal to be dissolved or precipitated as a negative electrode active material.
